(19) United States
(12) Patent Application Publication
(10) Pub. No.: US 2026/0087414 A1
(43) Pub. Date: Mar. 26, 2026

(54) TASK EXECUTION METHOD, LARGE MODEL TRAINING METHOD, DEVICE, AND STORAGE MEDIUM

(71) Applicant: BEIJING BAIDU NETCOM SCIENCE TECHNOLOGY CO., LTD., Beijing (CN)

(72) Inventors: Yixiong XIAO, Beijing (CN); Jingbo ZHOU, Beijing (CN)

(21) Appl. No.: 19/403,354

(22) Filed: Nov. 28, 2025

(30) Foreign Application Priority Data
Sep. 19, 2025 (CN) 202511349757.6

(51) Int. Cl. G06N 20/00

(52) U.S. Cl. CPC G06N 20/00

(57) ABSTRACT

A task execution method, a large model training method, a device, and a medium are provided, which relate to the field of artificial intelligence technologies, and in particular to the fields of deep learning, computer vision, and large model technologies. The task execution method includes: acquiring an input information for executing a target task, where the input information includes a task description information and a current state information of a task object; inputting the task description information into a guidance large model to generate a guidance information; and inputting the current state information, the task description information, and the guidance information into a task execution agent to output a task execution result, where the guidance information is configured to guide the task execution agent to execute the target task on the task object.

### CROSS-REFERENCE TO RELATED APPLICATIONS

This application claims the benefit of Chinese Patent Application No. 202511349757.6 filed on September 19, 2025, the whole disclosure of which is incorporated herein by reference.

### TECHNICAL FIELD

The present disclosure relates to the field of artificial intelligence technologies, and in particular to the fields of deep learning, computer vision, and large model technologies. More specifically, the present disclosure relates to a task execution method, a large model training method, a device, and a medium.

### BACKGROUND

With the rapid development of artificial intelligence technologies, especially the evolution of large language models and multimodal models, GUI (Graphical User Interface) agents have become a frontier direction in human-computer interaction. GUI agents are able to automatically complete a variety of tasks according to user input.

### SUMMARY

The present disclosure provides a task execution method, a large model training method, a device, and a medium.

According to an aspect of the present disclosure, a task execution method is provided, including: acquiring an input information for executing a target task, where the input information includes a task description information and a current state information of a task object; inputting the task description information into a guidance large model to generate a guidance information; and inputting the current state information, the task description information, and the guidance information into a task execution agent to output a task execution result, where the guidance information is configured to guide the task execution agent to execute the target task on the task object.

According to another aspect of the present disclosure, a large model training method is provided, including: training a pre-trained guidance large model using a sample information to obtain a guidance large model to be fine-tuned; inputting each first sample task description information into the guidance large model to be fine-tuned multiple times to generate a plurality of first sample guidance information for the first sample task description information; determining, for each first sample task description information, at least one positive sample and at least one negative sample according to the plurality of first sample guidance information for the first sample task description information; and fine-tuning the guidance large model to be fine-tuned according to the at least one positive sample and the at least one negative sample for the first sample task description information to obtain a guidance large model; where the guidance large model is configured to generate a guidance information according to a task description information in an input information, so as to input a current state information in the input information, the task description information, and the guidance information into a task execution agent to output a task execution result, and where the guidance information is configured to guide the task execution agent to execute a target task on a task object.

According to another aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to perform the methods described above.

According to another aspect of the present disclosure, a non-transitory computer-readable storage medium having computer instructions therein is provided, where the computer instructions are configured to cause a computer to perform the methods described above.

It should be understood that the content described in this section is not intended to identify key or essential features of embodiments of the present disclosure, nor is it intended to limit the scope of the present disclosure. Other features of the present disclosure will become easily understood through the following description.

### BRIEF DESCRIPTION OF THE DRAWINGS

The accompanying drawings are provided to facilitate a better understanding of the present disclosure and do not constitute limitations to the present disclosure. In the accompanying drawings:

FIG. 1 schematically shows an exemplary system architecture applicable to a task execution method and apparatus according to an embodiment of the present disclosure;

FIG. 2 schematically shows a flowchart of a task execution method according to an embodiment of the present disclosure;

FIG. 3 schematically shows a schematic diagram of a principle for generating a guidance information according to an embodiment of the present disclosure;

FIG. 4 schematically shows a flowchart of a large model training method according to an embodiment of the present disclosure;

FIG. 5 schematically shows a flowchart of a large model training method according to another embodiment of the present disclosure;

FIG. 6 schematically shows a flowchart of a method for training a task execution agent according to an embodiment of the present disclosure;

FIG. 7 schematically shows a structural block diagram of a task execution apparatus according to an embodiment of the present disclosure;

FIG. 8 schematically shows a structural block diagram of a large model training apparatus according to an embodiment of the present disclosure;

FIG. 9 schematically shows a structural block diagram of an artificial intelligence agent according to an embodiment of the present disclosure; and

FIG. 10 schematically shows a block diagram of an electronic device suitable for implementing the task execution method according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

A GUI agent is a universal intelligent assistant for webpages, desktops, and mobile terminals. It accepts natural language as input information from users and executes a corresponding target task. For example, when an input information for executing an invoice reimbursement task is input to the GUI agent, the GUI agent may automatically complete steps such as opening, retrieving, filling, switching, exporting, and archiving across different applications according to the input information. Its fundamental principle is to use a multimodal visual large model to jointly understand screenshots, OCR (Optical Character Recognition) text, accessibility trees/DOM (Document Object Model), window hierarchies, focus, and the like, extract interface semantics and operable controls, and generate stable actions such as clicking, inputting, scrolling, shortcuts, dragging, and file operations by combining user intent, and continue execution adaptively according to interface feedback until the objective is achieved. This provides advantages such as reducing repetitive labor across applications and minimizing manual operational errors. In related technologies, a user typically needs to manually add examples of task execution in the prompt information or recall similar examples from an example library, and then use a large model to execute the target task according to the prompt information. However, the accuracy of task execution in such methods depends on the manually provided examples or the examples in the example library. Once these examples fail to cover the task execution or are insufficiently precise, a task execution result may be adversely affected.

In view of the above, the present disclosure provides a task execution method, including: acquiring an input information for executing a target task, where the input information includes a task description information and a current state information of a task object; inputting the task description information into a guidance large model to generate a guidance information; and inputting the current state information, the task description information, and the guidance information into a task execution agent to output a task execution result, where the guidance information is used to guide the task execution agent to execute the target task on the task object.

According to the task execution method of the present disclosure, by generating a guidance information for each input task description information using an additional guidance large model, the guidance information may be more closely aligned with the target task, thereby improving the matching accuracy between the guidance information and the target task. The guidance information is then provided together with the task description information and the current state information of the task object as input to the task execution agent, so that the task execution agent may execute the target task on the task object according to the guidance information. This method does not rely on manually provided examples or examples in the example library, thereby improving specificity and enhancing task execution accuracy.

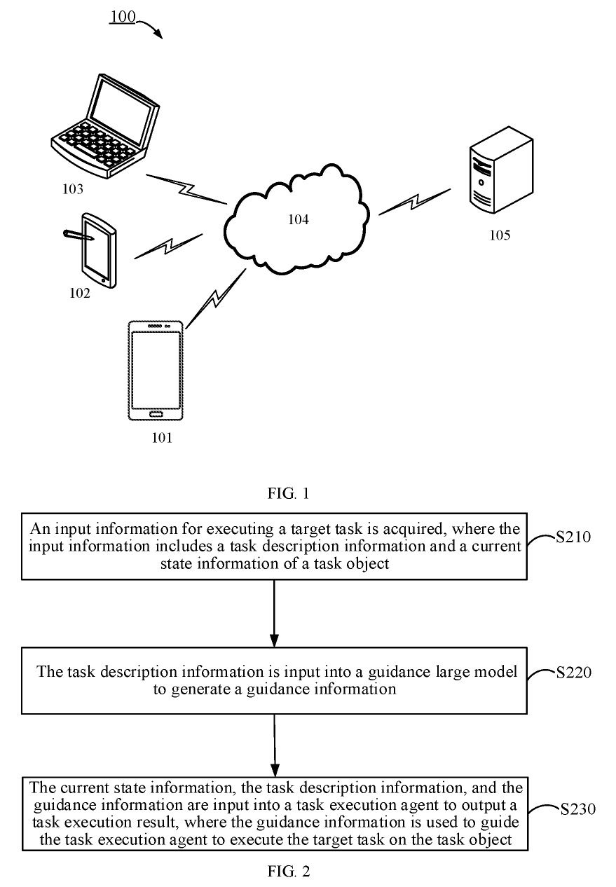

FIG. 1 schematically shows an exemplary system architecture applicable to a task execution method and apparatus according to an embodiment of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments, or scenarios. For example, in another embodiment, the exemplary system architecture applicable to the task execution method and apparatus may include a terminal device, but the terminal device may implement the task execution method and apparatus provided by embodiments of the present disclosure without interacting with a server.

As shown in FIG. 1, a system architecture 100 according to this embodiment may include a first terminal device 101, a second terminal device 102, a third terminal device 103, a network 104, and a server 105. The network 104 serves as a medium for providing a communication link between the first terminal device 101, the second terminal device 102, the third terminal device 103, and the server 105. The network 104 may include various types of connections, such as wired and/or wireless communication links.

The first terminal device 101, the second terminal device 102, and the third terminal device 103 may be used by a user to interact with the server 105 through the network 104 to receive or send messages, etc. The first terminal device 101, the second terminal device 102, and the third terminal device 103 may be installed with various communication client applications, such as knowledge reading applications, web browser applications, search applications, instant messaging tools, email clients, and/or social platform software, etc. (merely as examples).

The first terminal device 101, the second terminal device 102, and the third terminal device 103 may be various electronic devices having display screens and supporting web browsing, including but not limited to smart phones, tablet computers, laptop computers, and desktop computers, etc.

The server 105 may be a server providing various services, such as a background management server (merely as an example) that provides support for content browsed by the user using the first terminal device 101, the second terminal device 102, and the third terminal device 103. The background management server may analyze and process received data such as a user request, and return a processing result (such as a web page, information, or data acquired or generated according to the user request) to the terminal devices.

The server may be a cloud server, also known as a cloud computing server or cloud host, which is a host product in a cloud computing service system to solve shortcomings of difficult management and poor service scalability existing in traditional physical hosts and VPS (Virtual Private Server) services. The server may also be a server of a distributed system, or a server integrated with block-chain.

It should be noted that the task execution method and large model training method provided in embodiments of the present disclosure may generally be performed by the first terminal device 101, the second terminal device 102, or the third terminal device 103. Accordingly, the task execution apparatus and the large model training apparatus provided in embodiments of the present disclosure may be disposed in the first terminal device 101, the second terminal device 102, or the third terminal device 103.

Alternatively, the task execution method provided in embodiments of the present disclosure may be performed by the server 105. Accordingly, the task execution apparatus provided in embodiments of the present disclosure may be disposed in the server 105. The task execution method provided in embodiments of the present disclosure may also be performed by a server or server cluster different from the server 105 and capable of communicating with the first terminal device 101, the second terminal device 102, the third terminal device 103, and/or the server 105. Accordingly, the task execution apparatus provided in embodiments of the present disclosure may be disposed in a server or server cluster different from the server 105 and capable of communicating with the first terminal device 101, the second terminal device 102, the third terminal device 103, and/or the server 105. Further alternatively, the task execution method provided in embodiments of the present disclosure may generally be performed by the first terminal device 101, the second terminal device 102, or the third terminal device 103. Accordingly, the task execution apparatus provided in embodiments of the present disclosure may generally be disposed in the first terminal device 101, the second terminal device 102, or the third terminal device 103.

For example, a user is allowed to input a task description information and a current state information of a task object through an interactive interface of the first terminal device 101, the second terminal device 102, or the third terminal device 103. The first terminal device 101, the second terminal device 102, and the third terminal device 103 may acquire the task description information and the current state information of the task object and send the same to the server 105. The server 105 may invoke a large model to process the task description information and the current state information of the task object to generate a guidance information, and input the current state information, the task description information, and the guidance information into the task execution agent to output a task execution result, where the guidance information is used to guide the task execution agent to execute the target task on the task object.

It should be understood that the number of terminal devices, networks, and servers shown in FIG. 1 is merely illustrative. According to implementation needs, any number of terminal devices, networks, and servers may be provided.

In embodiments of the present disclosure, the collection, storage, use, processing, transmission, provision, disclosure, and application of user personal information involved all comply with relevant laws and regulations, adopt necessary confidentiality measures, and do not violate public order and good customs.

In the technical solutions of the present disclosure, user authorization or consent is obtained prior to the acquisition or collection of any user personal information.

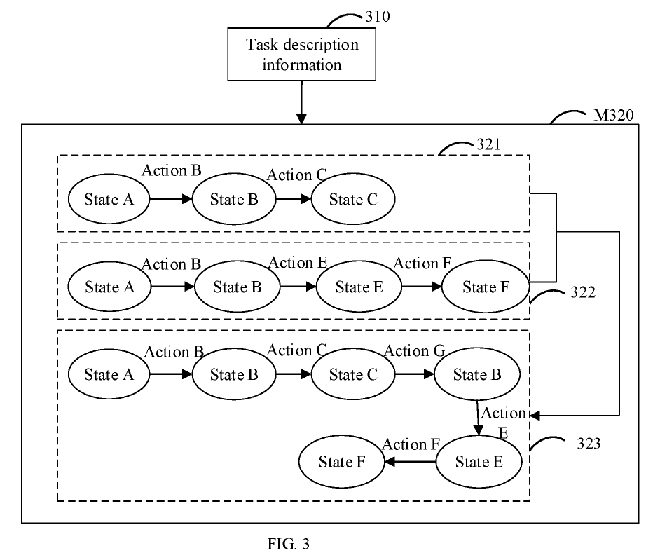

FIG. 2 schematically shows a flowchart of a task execution method according to an embodiment of the present disclosure.

As shown in FIG. 2, the task execution method includes operations S210 to S230.

In operation S210, an input information for executing a target task is acquired, where the input information includes a task description information and a current state information of a task object.

In operation S220, the task description information is input into a guidance large model to generate a guidance information.

In operation S230, the current state information, the task description information, and the guidance information are input into a task execution agent to output a task execution result, where the guidance information is used to guide the task execution agent to execute the target task on the task object.

In embodiments of the present disclosure, the task execution agent may be a GUI agent and may be applied in various scenarios such as webpages, desktops, and mobile terminals. A target task refers to a specific objective or function that the user expects the task execution agent to complete. The target task may be various tasks such as invoice reimbursement tasks, ticket booking tasks, document organization tasks, resource download tasks, and the like.

The task description information is an explanation of the target task, which may include requirements or constraints of the target task. For example, for a ticket booking task, the task description information may be "Please book me a flight to city A for tomorrow afternoon.".

The task object refers to elements related to the target task in a GUI interface, such as buttons, text boxes, icons, folders, and other various elements. The task execution agent may identify and operate the task object to complete the target task.

The current state information of the task object describes attributes or context of the task object at the time of execution. The current state information of the task object may include whether the task object exists, whether the task object is visible, whether the task object is operable, or other state information. The task object and the current state information of the task object may change continuously as the target task is executed.

The current state information of the task object may be obtained by the task execution agent parsing screenshots through computer vision technologies (such as OCR, image segmentation, and icon recognition) to acquire the position, type, and state of elements such as buttons, text boxes, icons, and folders.

For example, the task description information may be acquired in response to a user input on an interactive interface of the task execution agent, and the current state information of the task object may be acquired by parsing the interactive interface. The current state information and the task description information serve as the input information for executing the target task.

The guidance large model refers to a deep learning model having natural language understanding, logical reasoning, and structured output capabilities. The guidance large model may be, for example, a general large language model, a multimodal large model, or a large model dedicated to task planning. The present disclosure does not impose limitations to the type of the guidance large model.

For example, the guidance large model may parse the task description information to generate a structured guidance information. The guidance information may be composed of a combination of a plurality of action sequences for executing the target task, which serves as an example of a process for executing the target task.

The task execution agent may continuously operate on the task object according to the task description information and the current state information with reference to the guidance information until the target task is completed, and output a task execution result. The task execution result may be an indicator signaling a task completion, or may be a specific task objective.

According to embodiments of the present disclosure, by generating a guidance information for each input task description information using an additional guidance large model, the guidance information may be more closely aligned with the target task, thereby improving the matching accuracy between the guidance information and the target task. The guidance information is then provided together with the task description information and the current state information of the task object as input to the task execution agent, so that the task execution agent may execute the target task on the task object according to the guidance information. This method does not rely on manually provided examples or examples in the example library, thereby improving specificity and enhancing task execution accuracy.

In embodiments of the present disclosure, inputting the task description information into the guidance large model to generate a guidance information may include: performing semantic understanding on the task description information using the guidance large model to determine at least one subtask information; determining at least one action guidance information for each of the at least one subtask information; and generating the guidance information according to the at least one action guidance information for each of the at least one subtask information.

Exemplarily, by leveraging the understanding and reasoning capabilities of the guidance large model, the task description information may be deeply parsed to understand the user intent, context, and entity information. According to the user intent, context, and entity information, the target task may be decomposed into one or more subtasks, thereby obtaining one or more subtask information.

For example, the target task may be a single task. In this case, the target task may be decomposed into at least one subtask according to an execution order of the target task, and each subtask represents a sub-step of the target task. For example, a flight booking task may be decomposed into a plurality of subtasks including searching for flights, selecting a flight, filling in passenger information, and completing payment.

The action guidance information refers to specific steps or operation guidelines generated to accomplish each subtask. The action guidance information may include a current state, an action to be executed, and a state after the action is executed.

Exemplarily, one or more action guidance information may be combined according to the execution order of the subtasks to generate the guidance information.

Taking a flight booking task as an example, the task description information from the user may be "Please book me a flight from city A to city B for next Friday."

Through semantic understanding by the guidance large model, the user intent (booking a flight) and the entity information (departure: city A; destination: city B; date: next Friday) may be identified.

Based on the semantic understanding, the guidance large model may decompose the target task into a plurality of subtasks, which may include, for example: subtask 1 for searching for eligible flights, subtask 2 for selecting the optimal flight and initiating booking, subtask 3 for entering passenger information, and subtask 4 for completing payment.

For each subtask, the guidance large model may generate specific action guidance information. For example, for subtask 1, the action guidance information may include: visiting the airline website, entering departure city, destination, date, and cabin class, and executing the search. For subtask 2, the action guidance information may include: listing search results, selecting a flight according to user choice or automatic recommendation, confirming the flight, and clicking the “Book” button. For subtask 3, the action guidance information may include: entering passenger identity information and contact information into input fields. For subtask 4, the action guidance information may include: selecting a payment method, invoking a payment application, and clicking the “Confirm Payment” button. The action guidance information corresponding to the plurality of subtasks may be combined according to the execution order to obtain the guidance information.

According to embodiments of the present disclosure, by decomposing a complex task into fine-grained subtask information using the guidance large model and by determining corresponding action guidance information for each subtask, complex and ambiguous natural language instructions from users may be accurately transformed into concrete subtasks and fine-grained guidance, thereby improving the accuracy of the guidance information.

According to embodiments of the present disclosure, generating the guidance information according to the at least one action guidance information for each of the at least one subtask information may include: determining at least one switching action guidance information for switching between subtasks according to the at least one action guidance information for each of the plurality of subtask information; and generating the guidance information according to the at least one switching action guidance information and the at least one action guidance information for each of the plurality of subtask information.

Exemplarily, the target task may be a batch task or a task that includes a plurality of similar subtasks. In this case, the target task may be divided into a plurality of subtasks according to the number of items in the batch task.

For example, in a batch download of multiple resources, the download of each resource may be treated as a subtask. For another example, when purchasing multiple different items on a shopping platform, the purchase of each item may be treated as a subtask.

The switching action guidance information refers to an action guidance information connecting different subtasks, which is used to guide how to transition from a current subtask to a next subtask to ensure coherence and efficiency across different subtasks.

In related examples, when guiding the task execution agent to execute subtasks by adding examples of task execution in the prompt information or recalling similar examples from the example library, for any subtask, the execution starts from an initial action to an action completion according to the examples, which ignores the coherence between different subtasks, resulting in incoherent actions between different subtasks or redundant and complex operation steps.

In embodiments of the present disclosure, when the target task is a batch task or a task including a plurality of similar subtasks, the plurality of subtasks typically correspond to one or more identical or similar action guidance information. Accordingly, upon completion of a current subtask, when executing a next subtask, the next subtask may be switched, using a switching action guidance information, to a state corresponding to the identical or similar action guidance information.

For example, when executing an online shopping task, subtask 1 is to purchase item A, and subtask 2 is to purchase item B. The action guidance information for subtask 1 includes opening the shopping website, clicking the input box, entering item A for search, clicking on the purchase page of item A, and completing the payment. The action guidance information for subtask 2 includes opening the shopping website, clicking the input box, entering item B for search, clicking on the purchase page of item B, and completing the payment. Because subtask 1 and subtask 2 involve the same actions executed for opening the shopping website and clicking the input box and the same states after the actions are executed, after subtask 1 has been executed, it is possible to switch a state after completing payment of subtask 1 to a state after clicking the input box, and at least one action executed during the switching is referred to as a switching action guidance information. Based on the above operations, repetitive actions between subtasks may be avoided, thereby reducing the complexity of task execution and improving the flexibility of transitions between different subtasks.

According to embodiments of the present disclosure, determining at least one switching action guidance information for switching between subtasks according to the at least one action guidance information for each of a plurality of subtask information may include: determining similar action guidance information across the plurality of subtask information according to semantic features of the at least one action guidance information for each of the plurality of subtask information; determining an execution order of the plurality of subtask information according to positions of the similar action guidance information in the corresponding subtask information; and determining at least one switching action guidance information for switching between sub-tasks according to the execution order and the at least one action guidance information for each of the plurality of subtask information.

The similar action guidance information refers to action guidance information with highly overlapping semantic features in the plurality of subtask information.

Exemplarily, structured parsing may be performed on the action guidance information of the subtask information to extract the operation type, task object, parameters, and other features. A semantic similarity of action guidance information between different subtask information may then be determined through feature matching (e.g., cosine similarity) or rule engines (e.g., regular expression matching), and the action guidance information with a similarity exceeding a similarity threshold may be identified as similar action guidance information.

Exemplarily, according to the positions of the similar action guidance information in the corresponding subtask information, the number of steps remaining after the similar action in each subtask information may be determined, and the execution order of the plurality of subtask information may be determined according to the number of steps. For example, a subtask with a smaller number of remaining steps may be executed first.

Exemplarily, a position of the switching action guidance information may be determined according to the execution order. The at least one switching action guidance information may be determined according to a last action guidance information of a previous subtask and the similar action guidance information between the previous subtask and the current subtask. By using the at least one switching action guidance information, the current subtask may be located to the position of the similar action guidance information and executed accordingly. This improves the efficiency of transitions between different subtasks and reduces redundant operations.

FIG. 3 schematically shows a schematic diagram of a principle for generating a guidance information according to an embodiment of the present disclosure.

As shown in FIG. 3, a task description information 310 is input into a guidance large model M320. The guidance large model performs semantic understanding on the task description information 310 to determine at least one subtask information, such as a first subtask information 321 and a second subtask information 322.

The first subtask information 321 may include a plurality of action guidance information, for example, executing action B so that the task object transitions from state A to state B, and executing action C so that the task object transitions from state B to state C.

The second subtask information 322 may also include a plurality of action guidance information, for example, executing action B so that the task object transitions from state A to state B, executing action E so that the task object transitions from state B to state E, and executing action F so that the task object transitions from state E to state F.

The first subtask information 321 and the second subtask information 322 include identical action guidance information, such as executing action B so that the task object transitions from state A to state B. In the first subtask information 321, action B is followed by action C, whereas in the second subtask information 322, action B is followed by action E and action F. Therefore, during the task execution, the first subtask information 321 may be executed first, followed by the second subtask information 322.

Moreover, since the first subtask information 321 and the second subtask information 322 include identical action guidance information, after the first subtask information 321 has been executed, a switching action guidance information such as action G may be executed so that the target object transitions from state C to state B, and the execution of the second subtask information 322 may continue from state B. Accordingly, a guidance information 323 may be obtained, including: executing action B so that the task object transitions from state A to state B, executing action C so that the task object transitions from state B to state C, executing action G so that the task object transitions from state C to state B, executing action E so that the task object transitions from state B to state E, and executing action F so that the task object transitions from state E to state F.

Thus, the efficiency of transitions between different subtasks may be improved, and redundant operations may be reduced.

According to embodiments of the present disclosure, generating a guidance information according to the at least one action guidance information for each of the at least one subtask information may include: acquiring a type of the target object; and generating a guidance information in video modality according to the type and the at least one action guidance information for each of the at least one subtask information, where the guidance information is used to execute actions on a reference object according to the at least one action guidance information, and the reference object is of the same type as the target object.

The type of the target object refers to a result of classifying the target object according to its attributes, functions, or appearance features. The type of the target object may be, for example, a button, a text box, an icon, a folder, or the like. Information of different types helps the task execution agent accurately identify and understand the target object, and thus plan appropriate operations.

The guidance information in video modality refers to guidance content presented in the form of video, which dynamically demonstrating an operation process to guide the task execution agent in completing a specific task. The guidance information in video modality may contain visual elements such as interface screenshots or animation demonstrations. Optionally, the guidance information in video modality may further contain auditory elements such as voice narration or operation prompt sounds.

According to embodiments of the present disclosure, compared to guidance information in text modality or image modality, the guidance information in video modality is more intuitive and vivid, which may reduce user learning cost and improve operation efficiency.

According to embodiments of the present disclosure, after inputting the task description information into the guidance large model to generate a guidance information, the method may further include: displaying the guidance information; in response to an interactive operation performed on the guidance information, determining an updated guidance information according to the task description information; and in response to a confirmation operation performed on the updated guidance information, inputting the current state information, the task description information, and the updated guidance information into the task execution agent to output a task execution result.

Exemplarily, the guidance information may be displayed on the interface of the task execution agent in various modalities, for example, in multiple modes such as text steps, flowcharts, or videos.

Exemplarily, the guidance information may be editable information, and the interactive operation may include modifying, adding, or deleting the guidance information to obtain the updated guidance information.

According to embodiments of the present disclosure, after an initial guidance information is generated by the large model based on the task description and is displayed, the user may perform an interactive operation on the guidance information. In this case, it is possible to analyze user intent in real time by combining the original task description, and update the guidance information accordingly. After the updated guidance information is confirmed by the user, the current interface state, the complete task description, and the updated guidance information are synchronized to the task execution agent, so that the task execution agent generates an execution result accurately based on the latest context, thereby effectively improving the accuracy and adaptability of task execution.

According to embodiments of the present disclosure, determining an updated guidance information according to the task description information in response to an interactive operation performed on the guidance information may further include: in response to a first operation performed on the guidance information, re-inputting the task description information into the guidance large model to generate an updated guidance information different from the guidance information.

Exemplarily, the first operation may be an operation that triggers a regenerate command on the interactive interface, causing the guidance large model to reprocess the task description information and generate an updated guidance information. However, the present disclosure is not limited thereto. The user is allowed to provide a supplemental description information, and the guidance large model may process the task description information and the supplemental description information to generate an updated guidance information.

The user is allowed to perform the first operation multiple times until the updated guidance information meets user expectations. Thus, the matching degree between the guidance information and the target task may be further improved.

According to embodiments of the present disclosure, determining an updated guidance information according to the task description information in response to an interactive operation performed on the guidance information may further include: in response to a second operation performed on the guidance information, determining a historical task matching the task description information according to a historical dialogue information for an operation subject of the input information; and determining a guidance information for the historical task as the updated guidance information.

Exemplarily, the second operation may be an operation that triggers a command to use historical guidance information on the interactive interface.

Exemplarily, when retrieving the historical dialogue information, a retrieval scope may be set, such as only retrieving historical records from the past three months or only retrieving dialogue information related to keywords of the target task. A semantic similarity between the description information of the current task and each historical dialogue information may be calculated, then a historical task matching the task description information may be determined according to the similarity, and the guidance information for the historical task may then be determined as the updated guidance information.

By intelligently matching related tasks using the user's historical dialogue information and reusing previous effective guidance information in the current scenario, the accuracy and continuity of the guidance information may be enhanced through the inheritance of personalized historical data, thereby reducing repetitive operations and improving interaction efficiency.

According to embodiments of the present disclosure, inputting the current state information, the task description information, and the guidance information into the task execution agent to output a task execution result may include: learning the guidance information using the task execution agent; generating at least one action control information for changing a state of the task object, according to the current state information and the task description information using the task execution agent that has learned the guidance information; invoking a tool to execute an action indicated by the action control information to trigger a state change of the task object until the task object changes from a state indicated by the current state information to a final state of the target task, and outputting a task execution result with the task object in the final state.

Exemplarily, the task execution agent may learn a mapping relationship of "state of task object – execute action – new state of task object" from the guidance information. According to the learned mapping relationship in combination with the current state information and the task description information, the task execution agent may predict an action currently required to be executed and a state information to be obtained after the action is executed. At least one action control information may be generated according to the action currently required to be executed and the state information to be obtained after the action is executed.

The tool may be, for example, a user interface tool that simulates operations such as clicking and inputting. The tool may also be a system tool, such as a back button or a volume key, or may be a third-party interface tool, such as invoking a payment interface to complete payment.

Exemplarily, after invoking the tool to execute the action indicated by the action control information, it is possible to compare the current state of the task object with the predicted state to determine whether the current subtask has been completed. If the current subtask has been completed, a next subtask may be executed; if not, the process may roll back and retry. This continues until the task object reaches the final state, indicating that the target task is completed, and the task execution result is then output.

According to embodiments of the present disclosure, by enabling the task execution agent to learn the guidance information and dynamically generate targeted action control information according to the guidance information in combination with the current state and the task description information, it may be ensured that the task object progressively approaches the target state, and finally a verifiable and deterministic result is output. This improves the automation accuracy, environmental adaptability, and result predictability of complex interface task execution.

According to embodiments of the present disclosure, the task execution agent may include a plug-in guidance large model, so that the task execution agent inputs the task description information into the guidance large model to generate a guidance information, and the current state information, the task description information, and the guidance information are input into the task execution agent to output a task execution result.

The plug-in guidance large model refers to a guidance large model encapsulated as an independent plug-in, which communicates with the task execution agent through a standardized interface.

According to embodiments of the present disclosure, integrating the plug-in guidance large model into the task execution agent ensures both task execution accuracy and architectural flexibility, facilitating independent upgrade and update of the guidance large model.

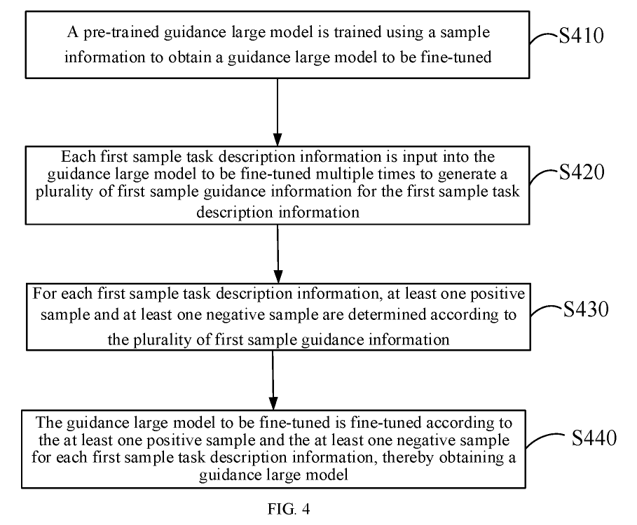

FIG. 4 schematically shows a flowchart of a large model training method according to an embodiment of the present disclosure

As shown in FIG. 4, the large model training method includes operations S410 to S440.

In operation S410, a pre-trained guidance large model is trained using a sample information to obtain a guidance large model to be fine-tuned.

In operation S420, each first sample task description information is input into the guidance large model to be fine-tuned multiple times to generate a plurality of first sample guidance information for the first sample task description information.

In operation S430, for each first sample task description information, at least one positive sample and at least one negative sample are determined according to the plurality of first sample guidance information for the first sample task description information.

In operation S440, the guidance large model to be fine-tuned is fine-tuned according to the at least one positive sample and the at least one negative sample for each first sample task description information, thereby obtaining a guidance large model.

The guidance large model is configured to generate a guidance information according to a task description information in an input information, so as to input a current state information in the input information, the task description information, and the guidance information into a task execution agent to output a task execution result. The guidance information is used to guide the task execution agent to execute a target task on a task object.

The pre-trained guidance large model may be a base language model that has undergone pre-training. Sample information refers to labeled training data, including sample pairs each including a sample task description information and a corresponding sample output. The pre-trained guidance large model may be initially fine-tuned in a supervised manner using the sample information to obtain a guidance large model to be fine-tuned. After the initial fine-tuning, the initially fine-tuned guidance large model may learn an interpretable and executable guidance style from the sample information and generate outputs covering the tasks.

The first sample task description information and the sample information may belong to the same data or originate from different data.

For a single first sample task description information, the guidance large model to be fine-tuned may be allowed to generate responses multiple times. Due to the stochastic nature of the generation process of the guidance large model to be fine-tuned, different first sample guidance information may be generated, thereby producing a rich and diverse set of outputs for each task.

A positive sample refers to a response identified as having higher quality and better compliance with the requirements among the plurality of responses generated by the guidance large model to be fine-tuned for the first sample task description information.

A negative sample refers to a response identified as having lower quality, containing errors, or failing to meet the requirements among the plurality of responses generated by the guidance large model to be fine-tuned for the first sample task description information.

Exemplarily, the plurality of first sample guidance information may be evaluated through manual annotation, large model-based evaluation, or preset rules, to determine the at least one positive sample and the at least one negative sample.

By fine-tuning the guidance large model to be fine-tuned using positive samples and negative samples, the guidance large model to be fine-tuned may perform contrastive learning and increases its tendency to generate responses that resemble the positive samples.

According to embodiments of the present disclosure, by using diverse outputs generated by the guidance large model to be fine-tuned itself as training data and combining contrastive learning based on positive samples and negative samples, the generalization capability and output quality of the guidance large model may be effectively improved. This not only enhances the accuracy of the guidance large model in understanding the task intent but also optimizes the reliability and alignment of generated results by distinguishing between high-quality responses and low-quality responses, ultimately achieving more precise and stable task guidance capabilities.

According to embodiments of the present disclosure, before training the pre-trained guidance large model using the sample information to obtain the guidance large model to be fine-tuned, the method may further include: acquiring a sample information to be processed, where the sample information to be processed includes a second sample task description information for executing a sample task, a first action execution path, and a sample task execution result, and the first action execution path includes at least one action and a state information of a sample task object corresponding to each action; reorganizing the first action execution path information to obtain a second action execution path, where the second action execution path includes the at least one action; and obtaining a sample information according to the second action execution path and the sample information to be processed.

The second sample task description information may serve as an input information to the pre-trained guidance large model, and the sample task execution result may serve as an output label of the pre-trained guidance large model.

The first action execution path may be a set of paths including multiple actions and multiple state information of task objects. Different actions may be combined to form different action execution sub-paths, and different action execution sub-paths may be used to execute different sample tasks.

Exemplarily, according to the second sample task description information, target action segments may be extracted from the first action execution path and then reorganized and concatenated to obtain the second action execution path. The second action execution path may serve as a reference execution path for the sample task.

Exemplarily, obtaining the sample information according to the second action execution path and the sample information to be processed may include: extracting the second sample task description information and the sample task execution result from the sample information to be processed, and obtaining the sample information according to the second action execution path, the second sample task description information, and the sample task execution result.

When training the pre-trained guidance large model using the sample information, the second sample task description information may serve as an input information, the second action execution path may serve as an execution module, and the sample task execution result may serve as a label for training, thereby obtaining the guidance large model to be fine-tuned.

According to embodiments of the present disclosure, determining at least one positive sample and at least one negative sample according to the plurality of first sample guidance information may include: determining a first evaluation result for each of the plurality of first sample guidance information by using an evaluation large model; determining a second evaluation result for each of the plurality of first sample guidance information by using an evaluation rule; and classifying the plurality of first sample guidance information into at least one positive sample and at least one negative sample according to the first evaluation results and the second evaluation results.

The evaluation large model may be a general large language model or a fine-tuned large language model. The present disclosure does not impose limitations on the type of the evaluation large model.

When the first sample guidance information is input into the evaluation large model, the evaluation large model may output a quantitative score (e.g., 0-100) or a classification label (e.g., "high quality", "medium quality", "low quality").

The evaluation rule may be a predefined automated rule based on hard metrics or logic. The evaluation rule may include, for example, a length rule, a format rule, and the like. The length rule may evaluate, for example, whether a length of the first sample guidance information meets a predetermined requirement. The format rule may verify, for example, whether the first sample guidance information conforms to a predetermined format required.

Exemplarily, a composite threshold may be set. A final score is calculated as: Final Score = Model Evaluation Score × Rule Evaluation Coefficient. If the rule evaluation passes, the coefficient is 1; if the rule evaluation fails, the coefficient is 0. The first sample guidance information with a final score higher than the composite threshold is classified as a positive sample, and the first sample guidance information with a final score lower than the composite threshold is classified as a negative sample.

According to embodiments of the present disclosure, by evaluating the content of the first sample guidance information using an evaluation large model and filtering the first sample guidance information using the evaluation rule, it is possible to achieve a comprehensive and reliable automatic construction of high-quality positive and negative sample pairs for training.

According to embodiments of the present disclosure, determining the first evaluation result for each of the plurality of first sample guidance information by using an evaluation large model may include: evaluating each first sample guidance information across multiple metric dimensions by using the evaluation large model to obtain evaluation sub-results for the metric dimensions; and determining the first evaluation result according to the evaluation sub-results for the metric dimensions.

Exemplarily, evaluating each first sample guidance information across multiple metric dimensions by using the evaluation large model may include: evaluating the first sample guidance information across multiple metric dimensions such as executability, coverage, consistency, conciseness, and safety by using the evaluation large model, to obtain evaluation sub-results for the metric dimensions.

Exemplarily, a weighted summation may be performed on the evaluation sub-results for the metric dimensions to obtain the first evaluation result.

By evaluating each first sample guidance information across multiple metric dimensions, the comprehensiveness of the evaluation for the first sample guidance information may be improved.

According to embodiments of the present disclosure, classifying the plurality of first sample guidance information into at least one positive sample and at least one negative sample according to the first evaluation results and the second evaluation results may include: determining a composite evaluation result for each first sample guidance information according to the corresponding first evaluation result and second evaluation result; determining a benchmark evaluation result according to each composite evaluation result for the corresponding first sample guidance information; and classifying the plurality of first sample guidance information into at least one positive sample and at least one negative sample according to the benchmark evaluation result and each composite evaluation result for the corresponding first sample guidance information.

Exemplarily, according to each composite evaluation result for the corresponding first sample guidance information, an average score or median of the plurality of first sample guidance information may be determined, which may serve as the benchmark evaluation result.

The first sample guidance information with a composite evaluation result higher than the benchmark evaluation result may be classified as a positive sample, while the first sample guidance information with a composite evaluation result lower than the benchmark evaluation result may be classified as a negative sample.

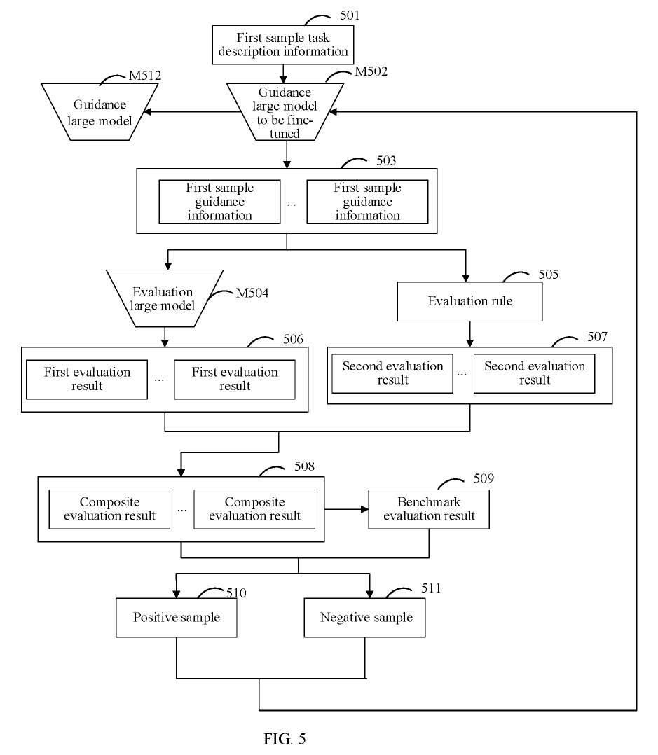

FIG. 5 schematically shows a flowchart of a large model training method according to another embodiment of the present disclosure.

As shown in FIG. 5, each first sample task description information 501 is input into a guidance large model to be fine-tuned M502 multiple times to generate a plurality of first sample guidance information 503 for that first sample task description information 501. The plurality of first sample guidance information 503 are input into an evaluation large model M504 to determine a first evaluation result 506 for each of the plurality of first sample guidance information 503. A second evaluation result 507 for each of the plurality of first sample guidance information 503 is determined using an evaluation rule 505. For each first sample guidance information 503, a composite evaluation result 508 is determined according to the corresponding first evaluation result 506 and second evaluation result 507. A benchmark evaluation result 509 is determined according to each composite evaluation result 508 for the corresponding first sample guidance information 501. The plurality of first sample guidance information 503 are then classified into at least one positive sample 510 and at least one negative sample 511 according to the benchmark evaluation result 509 and each composite evaluation result 508 for the corresponding first sample guidance information 503. The guidance large model to be fine-tuned M502 is fine-tuned according to the at least one positive sample 510 and the at least one negative sample 511 for each first sample task description information 501, thereby obtaining a guidance large model M512.

According to embodiments of the present disclosure, after determining the benchmark evaluation result according to each composite evaluation result for the corresponding first sample guidance information, the method may further include: determining a global evaluation difference information according to each benchmark evaluation result for the corresponding first sample task description information; updating each benchmark evaluation result for the corresponding first sample task description information according to the global evaluation difference information; and classifying, for each first sample task description information, the plurality of first sample guidance information into the at least one positive sample and the at least one negative sample according to the updated benchmark evaluation result and each composite evaluation result for the corresponding first sample guidance information.

The global evaluation difference information may be used to measure the difference or distribution of benchmark evaluation results between different sample tasks.

Exemplarily, the global evaluation difference information may include the standard deviation and variance of a plurality of benchmark evaluation results.

Exemplarily, updating each benchmark evaluation result for the corresponding first sample task description information according to the global evaluation difference information may include: performing a standardization or normalization adjustment on each benchmark evaluation result according to the standard deviation and variance of the plurality of benchmark evaluation results to obtain an updated benchmark evaluation result.

The first sample guidance information with a composite evaluation result higher than the updated benchmark evaluation result is classified as a positive sample, while the first sample guidance information with a composite evaluation result lower than the updated benchmark evaluation result is classified as a negative sample.

According to embodiments of the present disclosure, by introducing the global evaluation difference information to calibrate the benchmark evaluation results, the interference of task difficulty differences on sample quality evaluation is eliminated, ensuring that the classification of positive and negative samples is always based on a consistent relative quality standard, thereby improving the accuracy and reliability of model fine-tuning.

According to embodiments of the present disclosure, after fine-tuning the guidance large model to be fine-tuned according to at least one positive sample and at least one negative sample for each first sample task description information to obtain a guidance large model, the method may further include: acquiring a sample input information, where the sample input information includes a third task description information and a current state information of a sample task object; inputting the third task description information into the guidance large model to output a second sample guidance information; and fine-tuning the task execution agent using the third task description information, the current state information of the sample task object, and the second sample guidance information to obtain a fine-tuned task execution agent, so as to input the current state information in the input information, the task description information, and the guidance information into the fine-tuned task execution agent to output a task execution result.

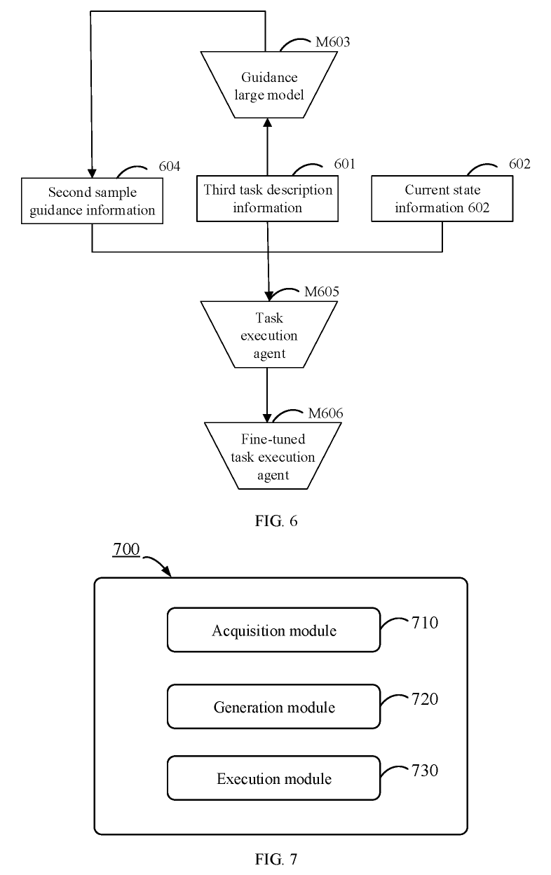

FIG. 6 schematically shows a flowchart of a method for training a task execution agent according to an embodiment of the present disclosure.

As shown in FIG. 6, a third task description information 601 is input into a guidance large model M603 to obtain a second sample guidance information 604. A task execution agent M605 is fine-tuned using the second sample guidance information 604, the third task description information 601, and a current state information 602 of a task object, thereby obtaining a fine-tuned task execution agent M606.

According to embodiments of the present disclosure, after the training of the guidance large model is completed, the task execution agent and the guidance large model are then used jointly, and the task execution agent is fine-tuned using the sample input information and the second sample guidance information output by the guidance large model, so that a collaborative optimization of the guidance large model and the task execution agent may be achieved, thereby improving the task execution accuracy of the task execution agent.

FIG. 7 schematically shows a structural block diagram of a task execution apparatus according to an embodiment of the present disclosure.

A task execution apparatus 700 includes an acquisition module 710, a generation module 720, and an execution module 730.

The acquisition module 710 is configured to acquire an input information for executing a target task, where the input information includes a task description information and a current state information of a task object.

The generation module 720 is configured to input the task description information into a guidance large model to generate a guidance information.

The execution module 730 is configured to input the current state information, the task description information, and the guidance information into a task execution agent to output a task execution result, where the guidance information is used to guide the task execution agent to execute the target task on the task object.

According to embodiments of the present disclosure, the generation module 720 includes a first determination submodule, a second determination submodule, and a first generation submodule. The first determination submodule is configured to perform semantic understanding on the task description information using the guidance large model to determine at least one subtask information.

The second determination submodule is configured to determine at least one action guidance information for each of the at least one subtask information.

The first generation submodule is configured to generate the guidance information according to the at least one action guidance information for each of the at least one subtask information.

According to embodiments of the present disclosure, the first generation submodule includes a first determination unit and a first generation unit.

The first determination unit is configured to determine at least one switching action guidance information for switching between subtasks according to the at least one action guidance information for each of the plurality of subtask information.

The first generation unit is configured to generate the guidance information according to the at least one switching action guidance information and the at least one action guidance information for each of the plurality of subtask information.

According to embodiments of the present disclosure, the first determination unit includes a first determination subunit, a second determination subunit, and a third determination subunit.

The first determination subunit is configured to determine similar action guidance information across the plurality of subtask information according to semantic features of the at least one action guidance information for each of the plurality of subtask information.

The second determination subunit is configured to determine an execution order of the plurality of subtask information according to positions of the similar action guidance information in the corresponding subtask information.

The third determination subunit is configured to determine at least one switching action guidance information for switching between subtasks according to the execution order and the at least one action guidance information for each of the plurality of subtask information.

According to embodiments of the present disclosure, the generation module 720 includes an acquisition submodule and a second generation submodule.

The acquisition submodule is configured to acquire a type of the target object.

The second generation submodule is configured to generate a guidance information in video modality according to the type and the at least one action guidance information for each of the at least one subtask information, where the guidance information is used to execute actions on a reference object according to the at least one action guidance information, and the reference object is of the same type as the target object.

According to embodiments of the present disclosure, the task execution apparatus 700 further includes a display module, a second determination module, and an execution module.

The display module is configured to display the guidance information.

The update module is configured to, in response to an interactive operation performed on the guidance information, determine an updated guidance information according to the task description information.

The execution module is configured to, in response to a confirmation operation performed on the updated guidance information, input the current state information, the task description information, and the updated guidance information into the task execution agent to output a task execution result.

According to embodiments of the present disclosure, the update module includes at least one of a first update submodule or a second update submodule.

The first update submodule is configured to, in response to a first operation performed on the guidance information, re-input the task description information into the guidance large model to generate the updated guidance information different from the guidance information.

The second update submodule is configured to, in response to a second operation performed on the guidance information, determine a historical task matching the task description information according to a historical dialogue information for an operation subject of the input information; and determine a guidance information for the historical task as the updated guidance information.

According to embodiments of the present disclosure, the execution module 730 includes a learning submodule, a third generation submodule, and an execution submodule.

The learning submodule is configured to learn the guidance information using the task execution agent.

The third generation submodule is configured to generate at least one action control information for changing a state of the task object according to the current state information and the task description information by using the task execution agent that has learned the guidance information.

The execution submodule is configured to invoke a tool to execute an action indicated by the action control information to trigger a state change of the task object until the task object changes from a state indicated by the current state information to a final state of the target task, and output a task execution result with the task object in the final state.

According to embodiments of the present disclosure, the task execution agent includes a plug-in guidance large model, so that the task execution agent inputs the task description information into the guidance large model to generate a guidance information, and the current state information, the task description information, and the guidance information are input into the task execution agent to output a task execution result.

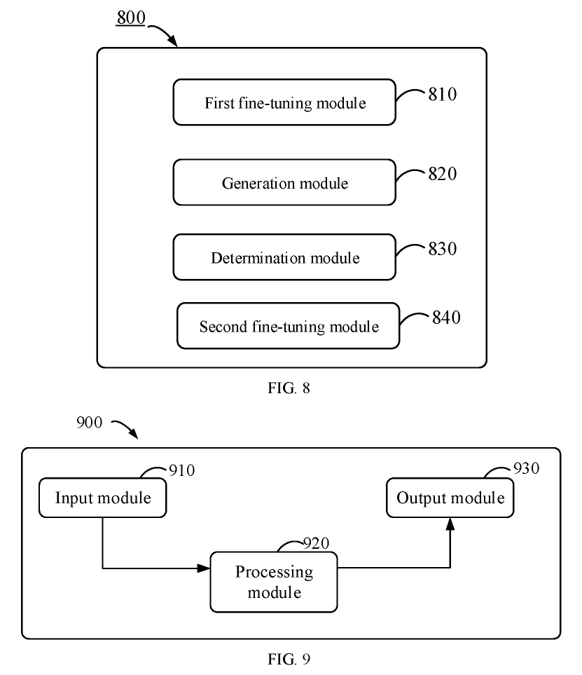

FIG. 8 schematically shows a structural block diagram of a large model training apparatus according to an embodiment of the present disclosure.

As shown in FIG. 8, a large model training apparatus 800 includes a first fine-tuning module 810, a generation module 820, a determination module 830, and a second fine-tuning module 840.

The first fine-tuning module 810 is configured to train a pre-trained guidance large model using a sample information to obtain a guidance large model to be fine-tuned.

The generation module 820 is configured to input each first sample task description information into the guidance large model to be fine-tuned multiple times to generate a plurality of first sample guidance information for the first sample task description information.

The determination module 830 is configured to, for each first sample task description information, determine at least one positive sample and at least one negative sample according to the plurality of first sample guidance information.

The second fine-tuning module 840 is configured to fine-tune the guidance large model to be fine-tuned according to the at least one positive sample and the at least one negative sample for each first sample task description information to obtain a guidance large model.

The guidance large model is configured to generate a guidance information according to the task description information in the input information, so as to input the current state information in the input information, the task description information, and the guidance information into a task execution agent to output a task execution result. The guidance information is used to guide the task execution agent to execute the target task on the task object.

According to embodiments of the present disclosure, the large model training apparatus 800 further includes a sample acquisition module, a path reorganization module, and a sample information determination module.

The sample acquisition module is configured to acquire a sample information to be processed, where the sample information to be processed includes a second sample task description information for executing a sample task, a first action execution path, and a sample task execution result, and the first action execution path includes at least one action and a state information of a sample task object corresponding to each action.

The path reorganization module is configured to reorganize the first action execution path information to obtain a second action execution path, where the second action execution path includes the at least one action.

The sample information determination module is configured to obtain a sample information according to the second action execution path and the sample information to be processed.

According to embodiments of the present disclosure, the determination module 830 includes a first sample determination submodule, a second sample determination submodule, and a sample classification submodule.

The first sample determination submodule is configured to determine a first evaluation result for each of the plurality of first sample guidance information by using an evaluation large model.

The second sample determination submodule is configured to determine a second evaluation result for each of the plurality of first sample guidance information by using an evaluation rule.

The sample classification submodule is configured to classify the plurality of first sample guidance information into at least one positive sample and at least one negative sample according to the first evaluation results and the second evaluation results.

According to embodiments of the present disclosure, the second sample determination submodule includes a first evaluation unit and a first evaluation result determination unit.

The first evaluation unit is configured to evaluate each first sample guidance information across multiple metric dimensions using the evaluation large model to obtain evaluation sub-results for the metric dimensions.

The first evaluation result determination unit is configured to determine the first evaluation result according to the evaluation sub-results for the metric dimensions.

According to embodiments of the present disclosure, the sample classification submodule includes a composite evaluation result determination unit, a benchmark evaluation result determination unit, and a sample classification unit.

The composite evaluation result determination unit is configured to determine a composite evaluation result for each first sample guidance information according to the corresponding first evaluation result and second evaluation result.

The benchmark evaluation result determination unit is configured to determine a benchmark evaluation result according to each composite evaluation result for the corresponding first sample guidance information.

The sample classification unit is configured to classify the plurality of first sample guidance information into at least one positive sample and at least one negative sample according to the benchmark evaluation result and each composite evaluation result for the corresponding first sample guidance information.

According to embodiments of the present disclosure, the large model training apparatus 800 further includes an evaluation difference determination module, an evaluation result update module, and a sample classification module.

The evaluation difference determination module is configured to determine a global evaluation difference information according to each benchmark evaluation result for the corresponding first sample task description information.

The evaluation result update module is configured to update each benchmark evaluation result for the corresponding first sample task description information according to the global evaluation difference information.

The sample classification module is configured to, for each first sample task description information, classify the plurality of first sample guidance information into at least one positive sample and at least one negative sample according to the updated benchmark evaluation result and each composite evaluation result for the corresponding first sample guidance information.

According to embodiments of the present disclosure, the large model training apparatus 800 further includes an input information acquisition module, an input module, and a third fine-tuning module.

The input information acquisition module is configured to acquire a sample input information, where the sample input information includes a third task description information and a current state information of a sample task object.

The input module is configured to input the third sample task description information into the guidance large model to output a second sample guidance information.

The third fine-tuning module is configured to fine-tune the task execution agent using the third task description information, the current state information of the sample task object, and the second sample guidance information to obtain a fine-tuned task execution agent, so as to input the current state information in the input information, the task description information, and the guidance information into the fine-tuned task execution agent to output a task execution result.

According to embodiments of the present disclosure, the present disclosure further provides an electronic device, a readable storage medium, and a computer program product.

According to embodiments of the present disclosure, an electronic device includes: at least one processor; and a memory communicatively connected to the at least one processor; where the memory stores instructions executable by the at least one processor, and the instructions are configured to, when executed by the at least one processor, cause the at least one processor to perform the methods described above.

According to embodiments of the present disclosure, a non-transitory computer- readable storage medium having computer instructions therein is provided, where the computer instructions are configured to cause a computer to perform the methods described above.

According to embodiments of the present disclosure, a computer program product including a computer program is provided, where the computer program is configured to, when executed by a processor, implement the methods described above.

FIG. 9 schematically shows a structural block diagram of an artificial intelligence agent according to an embodiment of the present disclosure.

In embodiments of the present disclosure, as shown in FIG. 9, an AI agent 900 may include an input module 910, a processing module 920, and an output module 930.

The input module 910 is configured to receive an input information.

The processing module 920 is configured to determine a target task based on the input information received by the input module, determine a large language model based on the target task, and perform the artificial intelligence-based video evaluation method provided according to embodiments of the present disclosure by invoking the large language model.

The output module 930 is configured to output the output information obtained by the processing module.

According to embodiments of the present disclosure, the input module 910 is responsible for receiving or perceiving information such as queries, requests, instructions, signals, or data from the outside (such as users or the external environment), and converting the information into a format that the AI agent 900 may understand and process. The input module 910 is a primary link for the AI agent 900 to interact with the outside world, enabling the AI agent 900 to efficiently and accurately acquire necessary "sensory" information from the outside world and make a response to the information.

In an example, the input module 910 may input the task description information, the input information, etc. described above.

In an example, the processing module 920 is a core support for the ability of the AI agent 900 to process complex tasks. The processing module 920 may perform the task execution method described above.

In an example, the performance of the processing module 920 may be closely related to the large model on which the AI agent 900 is based. To give full play to the capabilities of the large model, the internal structure of the processing module 920 may be designed to be highly configurable and extensible to meet various types of tasks and requirements in real scenarios.

In an example, after the AI agent 900 acquires the input, the processing module 920 may process the task description information to obtain a guidance information and transmit the guidance information to the output module 930.

It may be understood that although large language models have excellent language understanding and generation capabilities, the tasks they can accomplish without the aid of any tools are quite limited, just like humans. When the AI agent 900 is endowed with the capability to invoke tools, it becomes able to execute tasks such as performing mathematical operations using a calculator, performing data analysis through Python, or performing weather forecasts by means of a search engine.

In an example, the output module 930 may output the guidance information.

The AI agent 900 according to embodiments of the present disclosure may enhance the level of intelligence in a simple and effective manner and improve flexibility and generality.

According to embodiments of the present disclosure, the present disclosure further provides an electronic device, a readable storage medium, and a computer program product.

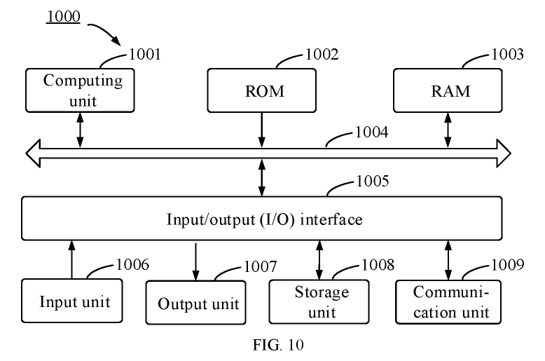

FIG. 10 schematically shows a block diagram of an electronic device suitable for implementing the task execution method according to an embodiment of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the input/output (I/O) interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and processes described above, such as the image search method. For example, in some embodiments, the image search method may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the image search method described above. Alternatively, in other embodiments, the computing unit 1001 may be used to perform the image search method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the data processing method of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A task execution method, comprising:
acquiring an input information for executing a target task, wherein the input information comprises a task description information and a current state information of a task object;
inputting the task description information into a guidance large model to generate a guidance information; and
inputting the current state information, the task description information, and the guidance information into a task execution agent to output a task execution result, wherein the guidance information is configured to guide the task execution agent to execute the target task on the task object.

2. The method of claim 1, wherein the inputting the task description information into a guidance large model to generate a guidance information comprises:
performing semantic understanding on the task description information by using the guidance large model to determine at least one subtask information;
determining at least one action guidance information for each of the at least one subtask information; and
generating the guidance information according to the at least one action guidance information for each of the at least one subtask information.

3. The method of claim 2, wherein the generating the guidance information according to the at least one action guidance information for each of the at least one subtask information comprises:
determining at least one switching action guidance information for switching between subtasks according to the at least one action guidance information for each of a plurality of subtask information; and
generating the guidance information according to the at least one action guidance information for each of the plurality of subtask information and the at least one switching action guidance information.

4. The method of claim 3, wherein the determining at least one switching action guidance information for switching between subtasks according to the at least one action guidance information for each of a plurality of subtask information comprises:
determining similar action guidance information across the plurality of subtask information according to semantic features of the at least one action guidance information for each of the plurality of subtask information;
determining an execution order of the plurality of subtask information according to positions of the similar action guidance information in each subtask information; and
determining the at least one switching action guidance information for switching between subtasks according to the execution order and the at least one action guidance information for each of the plurality of subtask information.

5. The method of claim 2, wherein the generating the guidance information according to the at least one action guidance information for each of the at least one subtask information comprises:
acquiring a type of a target object; and
generating a guidance information in a video modality according to the type and the at least one action guidance information for each of the at least one subtask information, wherein the guidance information is configured to execute actions on a reference object according to the at least one action guidance information, and the reference object is of the same type as the target object.

6. The method of claim 1, further comprising:
displaying the guidance information;
in response to an interaction operation performed on the guidance information, determining an updated guidance information according to the task description information; and
in response to a confirmation operation performed on the updated guidance information, inputting the current state information, the task description information, and the updated guidance information into the task execution agent to output the task execution result.

7. The method of claim 6, wherein the determining an updated guidance information according to the task description information in response to an interaction operation performed on the guidance information comprises at least one selected from:
in response to a first operation performed on the guidance information, re-inputting the task description information into the guidance large model to generate the updated guidance information different from the task description information; or
in response to a second operation performed on the guidance information, determining a historical task matching the task description information according to a historical dialogue information for an operation subject of the input information, and determining a guidance information for the historical task as the updated guidance information.

8. The method of claim 1, wherein the inputting the current state information, the task description information, and the guidance information into a task execution agent to output a task execution result comprises:
learning the guidance information using the task execution agent;
generating at least one action control information for changing a state of the task object, according to the current state information and the task description information using the task execution agent that has learned the guidance information; and
invoking a tool to execute an action indicated by the action control information to trigger a state change of the task object until the task object changes from a state indicated by the current state information to a final state of the target task, and outputting a task execution result with the task object in the final state.

9. A large model training method, comprising:
training a pre-trained guidance large model using a sample information to obtain a guidance large model to be fine-tuned;
inputting each first sample task description information into the guidance large model to be fine-tuned multiple times to generate a plurality of first sample guidance information for the first sample task description information;
determining, for each first sample task description information, at least one positive sample and at least one negative sample according to the plurality of first sample guidance information for the first sample task description information; and
fine-tuning the guidance large model to be fine-tuned according to the at least one positive sample and the at least one negative sample for the first sample task description information to obtain a guidance large model;
wherein the guidance large model is configured to generate a guidance information according to a task description information in an input information, so as to input a current state information in the input information, the task description information, and the guidance information into a task execution agent to output a task execution result, and wherein the guidance information is configured to guide the task execution agent to execute a target task on a task object.

10. The method of claim 9, further comprising:
acquiring a sample information to be processed, wherein the sample information to be processed comprises a second sample task description information for executing a sample task, a first action execution path, and a sample task execution result, and the first action execution path comprises at least one action and a state information of a sample task object corresponding to each action; and
reorganizing the first action execution path information to obtain a second action execution path, wherein the second action execution path comprises the at least one action; and
obtaining the sample information according to the second action execution path and the sample information to be processed.

11. The method of claim 10, wherein the determining at least one positive sample and at least one negative sample according to the plurality of first sample guidance information comprises:
determining a first evaluation result for each of the plurality of first sample guidance information by using an evaluation large model;
determining a second evaluation result for each of the plurality of first sample guidance information by using an evaluation rule; and
classifying the plurality of first sample guidance information into the at least one positive sample and the at least one negative sample according to the first evaluation result and the second evaluation result for each of the plurality of first sample guidance information.

12. The method of claim 11, wherein the classifying the plurality of first sample guidance information into the at least one positive sample and the at least one negative sample according to the first evaluation results and the second evaluation results comprises:
determining a composite evaluation result for each first sample guidance information according to the first evaluation result and the second evaluation result;
determining a benchmark evaluation result according to each composite evaluation result for the corresponding first sample guidance information; and
classifying the plurality of first sample guidance information into the at least one positive sample and the at least one negative sample according to the benchmark evaluation result and each composite evaluation result for the corresponding first sample guidance information.

13. The method of claim 11, further comprising:
determining a global evaluation difference information according to each benchmark evaluation result for the corresponding first sample task description information;
updating each benchmark evaluation result for the corresponding first sample task description information according to the global evaluation difference information; and
classifying, for each first sample task description information, the plurality of first sample guidance information into the at least one positive sample and the at least one negative sample according to the updated benchmark evaluation result and each composite evaluation result for the corresponding first sample guidance information.

14. The method of claim 9, further comprising:
acquiring a sample input information, wherein the sample input information comprises a third task description information and a current state information of the sample task object;
inputting the third task description information into the guidance large model to output a second sample guidance information;
fine-tuning the task execution agent using the third task description information, the current state information of the sample task object, and the second sample guidance information to obtain a fine-tuned task execution agent, so as to input the current state information in the input information, the task description information, and the guidance information into the fine-tuned task execution agent to output a task execution result.

15. An electronic device, comprising:
at least one processor; and
a memory communicatively connected to the at least one processor, wherein the memory stores instructions executable by the at least one processor, and the instructions are configured to, when executed by the at least one processor, cause the at least one processor to:
acquire an input information for executing a target task, wherein the input information comprises a task description information and a current state information of a task object;
input the task description information into a guidance large model to generate a guidance information; and
input the current state information, the task description information, and the guidance information into a task execution agent to output a task execution result, wherein the guidance information is configured to guide the task execution agent to execute the target task on the task object.

16. The electronic device of claim 15, wherein the at least one processor is further configured to:
perform semantic understanding on the task description information by using the guidance large model to determine at least one subtask information;
determine at least one action guidance information for each of the at least one subtask information; and
generate the guidance information according to the at least one action guidance information for each of the at least one subtask information.

17. The electronic device of claim 16, wherein the at least one processor is further configured to:
determine at least one switching action guidance information for switching between subtasks according to the at least one action guidance information for each of a plurality of subtask information; and
generate the guidance information according to the at least one action guidance information for each of the plurality of subtask information and the at least one switching action guidance information.

18. An electronic device, comprising:
at least one processor; and
a memory communicatively connected to the at least one processor, wherein the memory stores instructions executable by the at least one processor, and the instructions are configured to, when executed by the at least one processor, cause the at least one processor to perform the method of claim 9.

19. A non-transitory computer-readable storage medium having computer instructions therein, wherein the computer instructions are configured to cause a computer to perform the method of claim 1.

20. A non-transitory computer-readable storage medium having computer instructions therein, wherein the computer instructions are configured to cause a computer to perform the method of claim 9.
